(19) United States
(12) Patent Application Publication
(10) Pub. No.: US 2016/0110738 A1
(43) Pub. Date: Apr. 21, 2016

(54) METHOD FOR EXCHANGING CREATIVE WORK BY ELECTRONIC DEVICE AND ELECTRONIC DEVICE USING THE SAME

(71) Applicant: OVN CORPORATION, Seoul (KR)

(72) Inventor: Donghyeon KOH, Seoul (KR)

(21) Appl. No.: 14/519,681

(22) Filed: Oct. 21, 2014

(51) Int. Cl. G06Q 30/02

(52) U.S. Cl. CPC G06Q 30/0203

(57) ABSTRACT

A method for exchanging a creative work by an electronic device includes: receiving, by a design polling unit, an input for selecting the type of polling to be started from a first user group; receiving, by the design polling unit, at least one piece of information relating to the polling from the first user group; generating, by a design polling unit, polling on the basis of the type of polling and the at least one piece of information; receiving, by the design polling unit, an input for selecting one of creative works provided as candidates of the polling from a second user group; analyzing, by the design polling unit, a result of the polling on the basis of the received input; and providing, by the design polling unit, the analyzed result.

### BACKGROUND OF THE INVENTION

1. Field of the Invention

Various embodiments disclosed in the present disclosure relate to a method for exchanging a creative work by an electronic device and an electronic device using the same, and more particularly, to a method and an electronic device, which can provide various pieces of information on creative works to creators all over the world, thereby providing a more convenient and integrated environment.

2. Description of the Prior Art

With the recent increase in the consumers' aesthetic desire, the interest in new creative works is also increasing. As a result, the scale of the global creative work industry is gradually increasing. However, there is no inclusive and specialized global platform on which creators in different fields can exchange various creative works.

### SUMMARY OF THE INVENTION

Various embodiments disclosed in the present disclosure can provide a great number of creators throughout the world with a method for exchanging creative works and an electronic device using the same. In the present disclosure, a creative work may cover all fields relating to the creation, which include Two Dimensional/Three Dimensional (2D/3D) design, Web/multimedia design, product design, fashion design, Computer Graphic (CG), music, and marketing/advertisement, without being limited to a particular field. Concrete types of supported exchanges may include trend exchange, design polling, contents transaction, crowdsourcing, and creator showroom. As a result, it is possible to improve the work process relating to the creation of a creative work and provide an environment for transaction of a completed creative work.

A method for exchanging a creative work by an electronic device according to one of various embodiments disclosed in the present disclosure may include: receiving, by a design polling unit, an input for selecting the type of polling to be started from a first user group; receiving, by the design polling unit, at least one piece of information relating to the polling from the first user group; generating, by a design polling unit, polling on the basis of the type of polling and the at least one piece of information; receiving, by the design polling unit, an input for selecting one of creative works provided as candidates of the polling from a second user group; analyzing, by the design polling unit, a result of the polling on the basis of the received input; and providing, by the design polling unit, the analyzed result.

A creator intercommunication system according to one of various embodiments disclosed in the present disclosure includes a first user group; a second user group; and a server, wherein the server may include a design polling unit, which receives an input for selecting the type of polling to be started from the first user group, receives at least one piece of information relating to the polling from the first user group, generates polling based on the type of polling and the at least one piece of information, receives an input for selecting one of creative works provided as candidates of the polling from the second user group, analyzes a result of the polling based on the received input, and provides the analyzed result.

A computer-readable recording medium according to one of various embodiments disclosed in the present disclosure has a program recorded therein for executing operations in an electronic device, the operations including: receiving, by a design polling unit, an input for selecting the type of polling to be started from a first user group; receiving, by the design polling unit, at least one piece of information relating to the polling from the first user group; generating, by a design polling unit, polling on the basis of the type of polling and the at least one piece of information; receiving, by the design polling unit, an input for selecting one of creative works provided as candidates of the polling from a second user group; analyzing, by the design polling unit, a result of the polling on the basis of the received input; and providing, by the design polling unit, the analyzed result.

Various embodiments disclosed in the present disclosure can provide a great number of creators throughout the world with a method for exchanging creative works and an electronic device using the same. As a result, it is possible to improve the work process relating to the creation of a creative work and provide an environment for transaction of a completed creative work.

### BRIEF DESCRIPTION OF THE DRAWINGS

The above and other objects, features and advantages of the present invention will be more apparent from the following detailed description in conjunction with the accompanying drawings, in which:

FIG. 1 briefly illustrates the construction of a creator intercommunication system according to one of various embodiments disclosed in the present disclosure;

FIG. 2 illustrates the construction of a server included in a creator intercommunication system according to one of various embodiments disclosed in the present disclosure;

FIG. 3 is a flowchart for describing a method for starting polling by a design polling unit according to one of various embodiments disclosed in the present disclosure;

FIG. 4 illustrates an interface for starting polling provided by a design polling unit according to one of various embodiments disclosed in the present disclosure;

FIG. 5 illustrates an interface showing polling results provided by a design polling unit according to one of various embodiments disclosed in the present disclosure; and

FIG. 6 illustrates an interface for searching for a design, which is provided by a design search unit according to one of various embodiments disclosed in the present disclosure.

### DETAILED DESCRIPTION OF THE EXEMPLARY EMBODIMENTS

Hereinafter, various embodiments will be described in detail with reference to the accompanying drawings. It should be noted that the same elements will be designated by the same reference numerals although they are shown in different drawings. Further, a detailed description of a known function and configuration which may make the subject matter of the present invention unclear will be omitted. Hereinafter, it should be noted that only the descriptions will be provided that may help understanding the operations provided in association with the various embodiments of the present invention, and other descriptions will be omitted to avoid making the subject matter of the present invention rather unclear.

The embodiments disclosed in the present specifications and drawings are provided merely to readily describe and to help a thorough understanding of the present invention but are not intended to limit the scope of the present invention. Therefore, it should be construed that all modifications or modified forms drawn by the technical idea of the present invention in addition to the embodiments disclosed herein are included in the scope of the present invention.

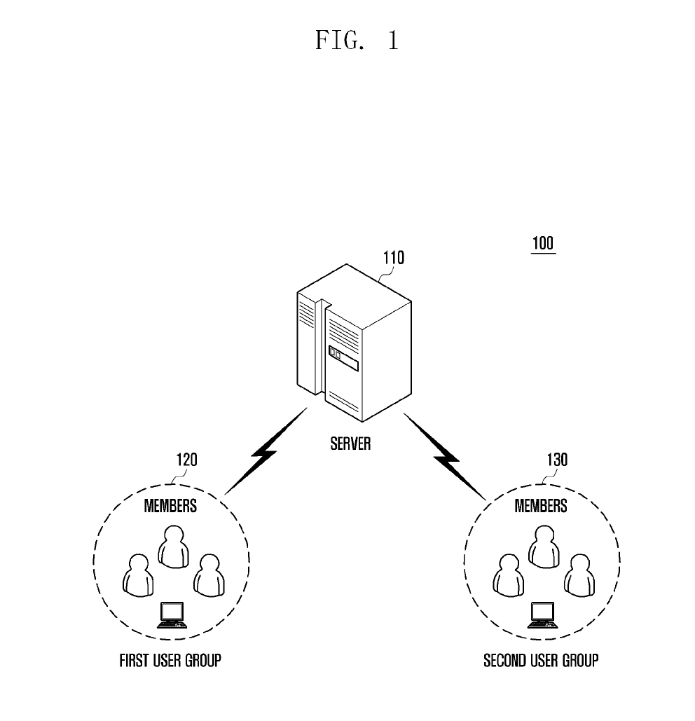

FIG. 1 briefly illustrates the construction of a creator intercommunication system according to one of various embodiments disclosed in the present disclosure.

Referring to FIG. 1, a creator intercommunication system 100 may include a server 110, a first user group 120, and a second user group 130.

The creator intercommunication system 100 may provide an intercommunication system to the first user group 120 and the second user group 130. The creator intercommunication system 100 can support the exchange of creative works in all fields including 2D/3D design, Web/multimedia design, product design, fashion design, Computer Graphics (CG), music, and marketing/advertisement, without being limited to a particular field. Concrete types of supported exchanges may include trend exchange, design polling, contents transaction, crowdsourcing, and creator showroom. Therefore, through the creator intercommunication system 100, it is possible to improve the work process relating to the creation of a creative work and provide an environment for transaction of a completed creative work.

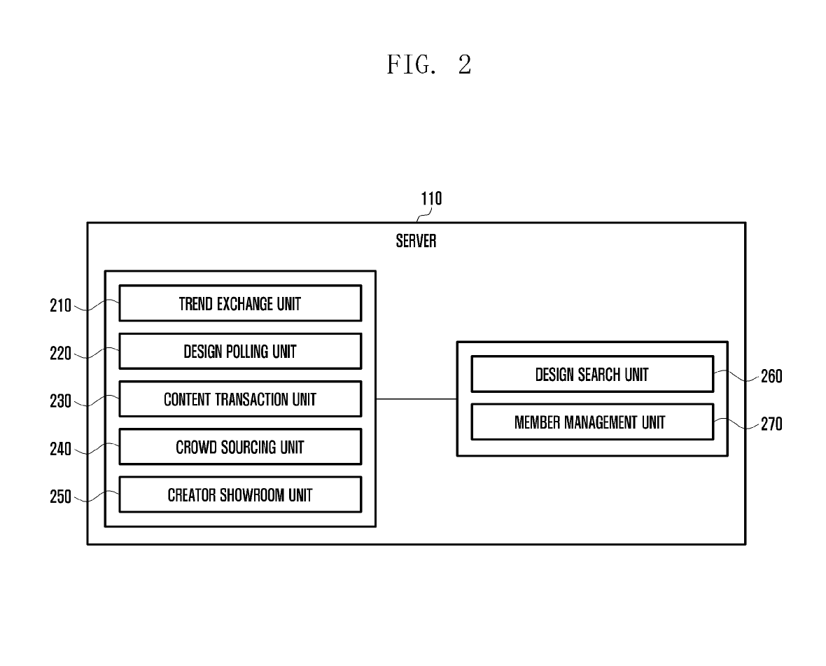

The server 110 can interconnect the first user group 120 and the second user group 130 on a network. Concrete elements of the server 110 will be described in more detail with reference to FIG. 2.

The first user group 120 and the second user group 130 can access the creator intercommunication system 100 through the server 110 and can execute various contents of the creator intercommunication system 100.

For example, in the trend exchange, if the first user group 120 uploads a creative work to the server 110, the second user group 130 can freely evaluate the creative work. Further, in the design polling, if the first user group 120 starts polling on a creative work, the second user group 130 can participate in the polling through the server 110.

Meanwhile, the first user group 120 and the second user group 130 are not unchangeable and can be changed any time according to the function which an individual member performs in the server 110. For example, an individual member may belong to the first user group 120 when the individual member registered in the server 110 performs the function of a seller in transaction of a creative work, or to the second user group 130 when the individual member performs the function of a buyer.

A creator intercommunication system according to various embodiments of the present invention includes a first user group; a second user group; and a server, wherein the server may include a design polling unit, which receives an input for selecting the type of polling to be started from the first user group, receives at least one piece of information relating to the polling from the first user group, generates polling based on the type of polling and the at least one piece of information, receives an input for selecting one of creative works provided as candidates of the polling from the second user group, analyzes a result of the polling based on the received input, and provides the analyzed result.

The server may further include a trend exchange unit, which receives data relating to at least one creative work from the first user group, provides the data relating to the creative work to the second user group, receives evaluation on the creative work from the second user group, and provides the evaluation to the first user group and the second user group, thereby achieving the exchange of the trend relating to the creative work.

The server may further include a content transaction unit, which receives data relating to at least one content from the first user group, provides the data relating to the content to the second user group, and receives purchase intention for the content from the second user group, thereby mediating content transaction between the first user group and the second user group.

The server may further include a crowdsourcing unit, which receives data relating to a project order from the first user group, provides the data relating to the project order to the second user group, and receives a participation intention relating to the project order from the second user group, thereby mediating a project order transaction between the first user group and the second user group.

The server may further include a creator showroom unit, which provides personal on-line spaces for individual members belonging to the first user group and the second user group.

The server may further include a design search unit, which searches for at least one creative work uploaded to the creator intercommunication system.

The server may further include a member management unit, which manages the grade of at least one member of the creator intercommunication system and benefits corresponding to the grade.

FIG. 2 illustrates the construction of a server included in a creator intercommunication system according to one of various embodiments disclosed in the present disclosure.

The server 110 may include at least one from among a trend exchange unit 210, a design polling unit 220, a content transaction unit 230, a crowdsourcing unit 240, a creator showroom unit 250, a design search unit 260, and a member management unit 270.

Through the elements described above, the server 110 can provide an environment in which the first user group 120 and the second user group 130 can intercommunicate on-line in relation to a creative work.

The trend exchange unit 210 can provide an environment in which members can exchange their opinions on the latest trend in relation to a creative work. The trend exchange unit 210 may receive data relating to a creative work from the first user group 120. The trend exchange unit 210 may provide the data relating to the creative work to the second user group 130 and may receive an evaluation on the corresponding design from the second user group 130. The trend exchange unit 210 may provide the evaluation to both the first user group and the second user group. Through the above process, the trend exchange unit 210 can collect various opinions of creators on a certain creative work and provide feedbacks thereof in real time.

Specifically, the trend exchange unit 210 may receive various types of information when receiving data relating to a creative work from the first user group 120. For example, the trend exchange unit 210 may receive at least one piece of data from among category, title, contents, tag, color code, thumbnail, and attached image file of a creative work, from the first user group 120.

Further, the trend exchange unit 210 may receive information of various fields when receiving the evaluation relating to a creative work from the second user group 130. For example, the trend exchange unit 210 may receive scores relating to User Interface (UI) design, usability, creativity, interactivity, and contents, which are individual evaluation elements of a creative work, from the second user group 130, and may receive general comments relating to the creative work. Further, the trend exchange unit 210 may calculate an average score on the basis of the individual evaluation elements and provide the calculated average score to the first user group 120 and the second user group 130.

The design polling unit 220 may survey the preference for a particular creative work among at least two creative works. The design polling unit 220 may receive data relating to at least two creative works, which are to be subjected to polling, from the first user group 120. The trend exchange unit 220 may start the polling by providing the data relating to the at least two creative works to the second user group 130, and may receive the preference for a particular creative work from the second user group 130. The trend exchange unit 220 may selectively provide a result of the polling to both the first user group and the second user group. Specifically, a member who has requested polling may select “Open to only myself,” “Open to members participating in the polling,” or “Open to all members.” Through the above process, the design polling unit 220 can quantitatively collect the preference of creators throughout the world relating to a creative work, and thus can exactly provide information relating to the preference and demands on the creative work.

Specifically, the design polling unit 220 may receive information of various fields when receiving data relating to a creative work, which is to be subject to polling, from the first user group 120. For example, the design polling unit 220 may receive at least one piece of data from among category, title, contents, tag, color code, time limit, whether to open the result of polling, number of polling images, thumbnail, and polling image file of a creative work, from the first user group 120.

Meanwhile, in starting the polling, the design polling unit 220 may provide different types of polling, including first polling and second polling. The first polling may be simple polling for surveying only the preference on at least two creative works. In contrast, the second polling may include not only the basic preference survey but also a survey of preferences classified according to specific conditions. For example, in the second polling, the design polling unit 220 may survey the individual preference of members participating in the polling according to the nations, cultural areas, ages, sexes, and fields to which they belong. Therefore, since the first user group 120 having requested the polling can easily identify the preferences according to the specific conditions, the first user group 120 can easily acquire core materials in establishing a future product launching plan.

Further, in progressing the polling, the design polling unit 220 may limit a member in a particular condition. For example, the design polling unit 220 may analyze the polling history according to the past polling in which a member already participated, and may prohibit the member from participating in new polling by a predetermined number of times or for a predetermined time period if the member selected a creative work of the lowest preference by more than a preset number of times in the past polling. Otherwise, instead of prohibiting the member from participating in new polling, the design polling unit 220 may provide a result including a preference analysis in which the selection of the member has been excluded, to the first user group 120 and the second user group 130.

The content transaction unit 230 may provide an environment in which members can sell contents to each other. The content transaction unit 230 may receive data relating to a certain content from the first user group 120. The content transaction unit 230 may provide the data relating to the content to the second user group 130. The content transaction unit 230 may receive a purchase intention for the content from the second user group 130. That is, the content transaction unit 230 can mediate the content transaction between the first user group 120 and the second user group 130.

Specifically, the content transaction unit 230 may receive information of various fields when receiving data relating to a content from the first user group 120. For example, the content transaction unit 230 may receive at least one piece of data from among category, title, context, tag, color code, price, resource, thumbnail, and attached image file of a content, from the first user group 120. Therefore, the content transaction unit 230 may mediate the transaction by providing the second user group 130 with the information on the content received from the first user group 120.

The crowdsourcing unit 240 may provide an environment in which it is possible to order a project relating to production of a content. The crowdsourcing unit 240 may receive data relating to the project order from the first user group 120. The project ordered by the first user group 120 may relate to either all or a part of a certain creative work. The crowdsourcing unit 240 may provide the data relating to the project to the second user group 130 to induce the second user group 130 to participate in the project.

The crowdsourcing unit 240 may receive an intention to participate in the project from the second user group 130. In this process, the crowdsourcing unit 240 may receive a sample relating to the project from the second user group 130. The crowdsourcing unit 240 may transmit the sample and the participation intention of the second user group 130 to the first user group 120. Therefore, through the crowdsourcing unit 240, the first user group 120 can identify the sample and the participation intention of individual members belonging to the second user group 130, and select at least one individual member who is to proceed with the project. The crowdsourcing unit 240 may receive a selection intention from the first user group 120 and transfer the received selection intention to the individual members who have participated in the project and belong to the second user group 130. That is, the crowdsourcing unit 240 can mediate the project order and participation therein between the first user group 120 and the second user group 130.

The creator showroom unit 250 may provide an on-line personal space to the individual members belonging to the first user group 120 and the second user group 130. Through the creator showroom, the creators can promote their creative works and communicate with various other creators in relation to creative works. In the creator showroom, activity particulars of individual members in the creator intercommunication system 100 may be recorded. Of course, whether to open the activity particulars may depend on a configuration made by a member.

The design search unit 260 may provide an interface through which it is possible to search for a creative work uploaded to the server 110 of the creator intercommunication system 100. In transmitting materials relating to a creative work to the trend exchange unit 210, the design polling unit 220, the content transaction unit 230, the crowdsourcing unit 240, and the creator showroom unit 250, each of the individual members belonging to the first user group 120 and the second user group 130 can input information of various fields. For example, they may input information, such as category, title, context, tag, color code, and price of a creative work. Therefore, the design search unit 260 may provide members using the creator intercommunication system 100 with an incorporated environment in which the members can search for a creative work, using the input information. Especially, the design search unit 260 can search for a creative work, using a color code of an uploaded creative work. Specifically, the design search unit 260 may receive a color code to be searched for from a member, find at least one creative work corresponding to the color code, and provide the found creative work to the member. Therefore, the design search unit 260 may provide an incorporated environment in which a member can easily search for a creative work including a color code in all fields, using only the color code.

The member management unit 270 may manage members of the first user group 120 and the second user group 130 belonging to the creator intercommunication system 100. That is, the member management unit 270 may receive information of various fields from people who want to join the creator intercommunication system 100 and approve the people as members thereof. Meanwhile, the member management unit 270 may receive information, such as nations, cultural areas, ages, sexes, and fields, of the people who want to join, and share such information with various modules (e.g. the trend exchange unit 210 and the design polling unit 220) included in the server 110.

The member management unit 270 may manually adjust the grades of the members who have joined the creator intercommunication system 100. For example, in order to initially acquire a seller grade, a member may upload information on a creative work, which the member wants to sell, through the content transaction unit 230. When a member who has not acquired a seller grade uploads information on a creative work to the content transaction unit 230, the member management unit 270 may manually perform an examination on the creative work and may adjust the member grade of the member according to a result of the examination.

Further, the member management unit 270 may automatically adjust the grades of the members who have joined the creator intercommunication system 100. For example, the member management unit 270 may automatically elevate the member grade of a member who has acquired a score higher than a preset number of times, a preset price, or preset points in view of the member subscription duration, the number of times of purchase, the number of times of sales, the transaction price, and the activity points.

The member management unit 270 may provide various benefits according to the adjusted member grade. For example, the member management unit 270 may lower the sales charge or elevate the discount rate at the time of purchase, according to the member grade. Through these benefits, it is possible to encourage active participation of the members in the creator intercommunication system 100.

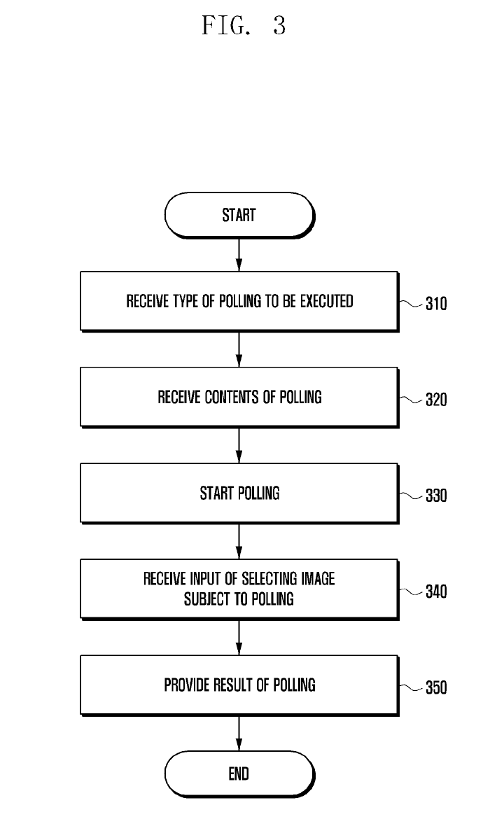

FIG. 3 is a flowchart for describing a method for starting polling by a design polling unit according to one of various embodiments disclosed in the present disclosure.

In operation 310, the design polling unit 220 may receive the type of polling to be executed, from the first user group 120. Specifically, in starting the polling, the design polling unit 220 may provide first polling or second polling. The first polling may be simple polling for surveying only the preference on at least two creative works. In contrast, the second polling may include not only the basic preference survey but also a survey of preferences classified according to specific conditions. For example, in the second polling, the design polling unit 220 may survey the individual preference of members participating in the polling according to the nations, cultural areas, ages, sexes, and fields to which they belong. Therefore, since the first user group 120 having requested the polling can easily identify the preferences according to the specific conditions, the first user group 120 can easily acquire core materials in establishing a future product launching plan.

In operation 320, the design polling unit 220 may receive detailed information relating to contents of the polling to be executed, from the first user group 120. For example, the design polling unit 220 may receive data relating to at least one from among category, title, contents, tag, color code, time limit, whether to open the result of polling, number of polling images, thumbnail, and polling image file of a creative work to be subject to the polling, from the first user group 120.

In operation 330, the design polling unit 220 may start the polling on the basis of the data received in operation 310 and operation 320. Further, in operation 330, the design polling unit 220 may proceed with the polling while limiting a member in a particular condition. For example, the design polling unit 220 may analyze the polling history according to the past polling in which a member already participated, and may prohibit the member from participating in new polling by a predetermined number of times or for a predetermined time period if the member selected a creative work of the lowest preference by more than a preset number of times in the past polling.

In operation 340, the design polling unit 220 may receive an input of selecting at least one image from among at least two images, which are being subject to polling, from the second user group 130. The design polling unit 220 may receive the input of selection from the second user group 130 until the time limit set in operation 320 expires.

In operation 350, the design polling unit 220 may provide a result of the polling to the member who has requested the polling. The design polling unit 220 may open a result of the polling according to the configuration set in operation 320 relating to whether to open the result of the polling. Specifically, a member who has requested polling may select “Open to only myself,” “Open to members participating in the polling,” or “Open to all members.”

Meanwhile, in operation 350, the design polling unit 220 may analyze the polling history according to the past polling which a member already participated, and may provide the result of the polling, in which the selection of the member is excluded from the preference analysis, if the member selected a creative work of the lowest preference by more than a preset number of times in the past polling.

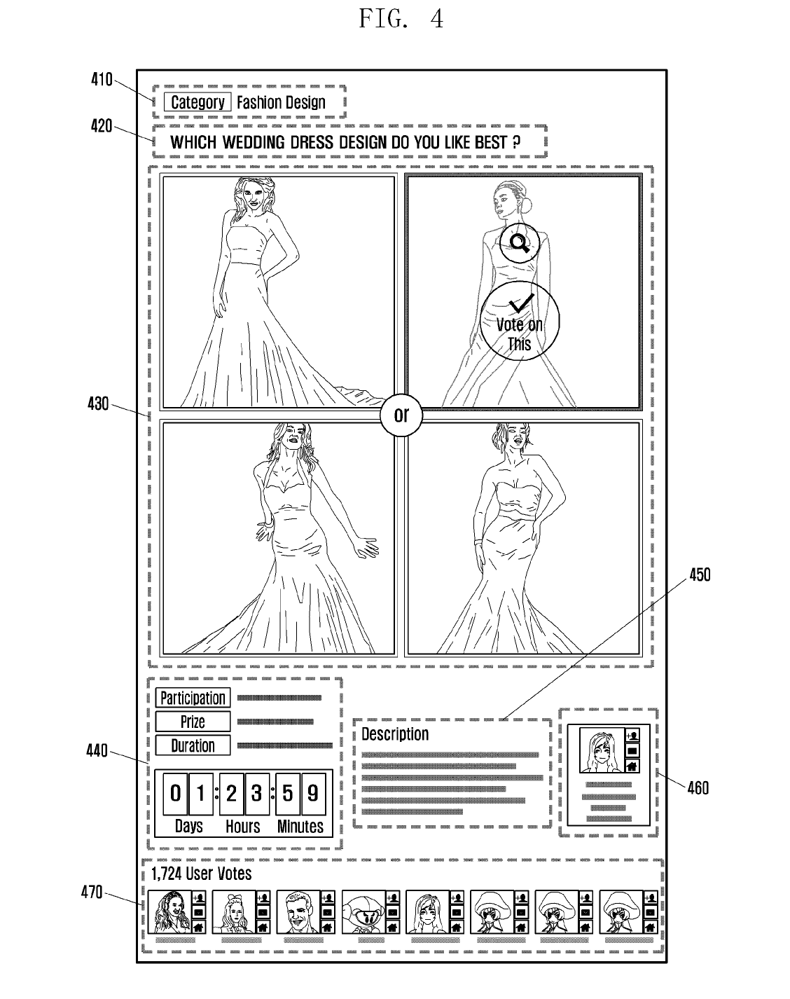

FIG. 4 illustrates an interface for starting polling provided by a design polling unit according to one of various embodiments disclosed in the present disclosure.

The design polling unit 220 may display a category 410 of the polling. For example, the design polling unit 220 may proceed with polling relating to a fashion design in FIG. 4.

The design polling unit 220 may display a title 420 of the polling. For example, the design polling unit 220 may proceed with polling with a title “Which wedding dress design do you like best?” in FIG. 4.

The design polling unit 220 may display at least two images 430 to be subject to the polling. For example, the design polling unit 220 may proceed with polling for four types of wedding dresses in FIG. 4 and receive an input of selecting a wedding dress design from the members.

The design polling unit 220 may display conditions 440 of the polling. For example, the design polling unit 220 may display the objectives invited to participate in the polling, the prize money for participation in the polling, and the time limit in FIG. 4.

The design polling unit 220 may display details 450 of the polling, a profile 460 of the member having started the polling, and profiles 470 of the members who participated in the polling.

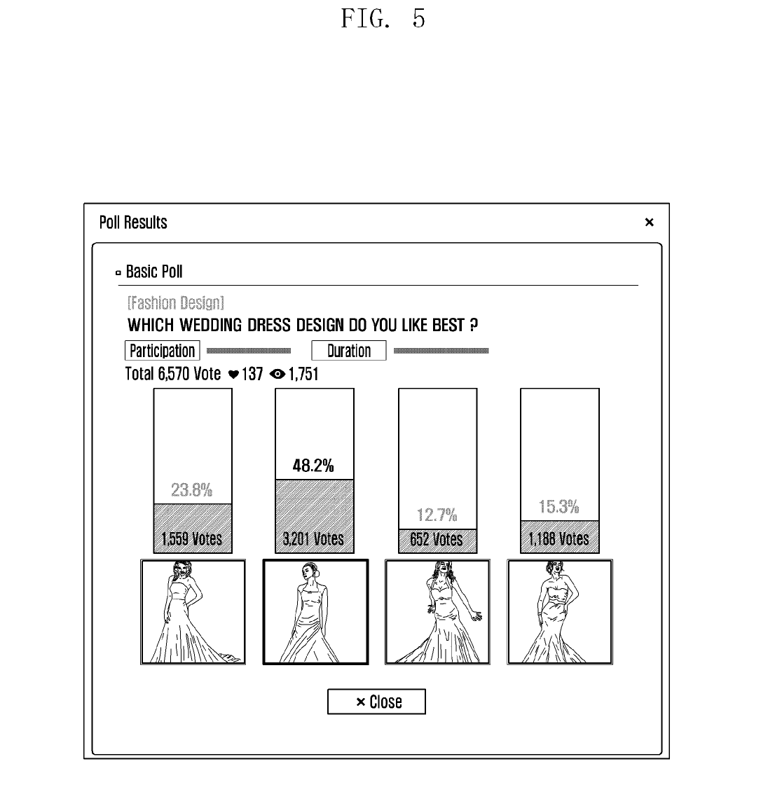

FIG. 5 illustrates an interface showing polling results provided by a design polling unit according to one of various embodiments disclosed in the present disclosure.

Referring to FIG. 5, the design polling unit 220 may provide results of the polling together with the category, title, and conditions of the polling. The results of the polling may provide basic polling results by displaying the total number of participants, the number of times by which each image has been selected, and the percentage. Meanwhile, in the case of high class polling rather than the basic polling, the design polling unit 220 may provide minutely filtered polling results, such as nation-specific results, cultural area-specific results, age-specific results, and sex-specific results, as well as the basic polling results.

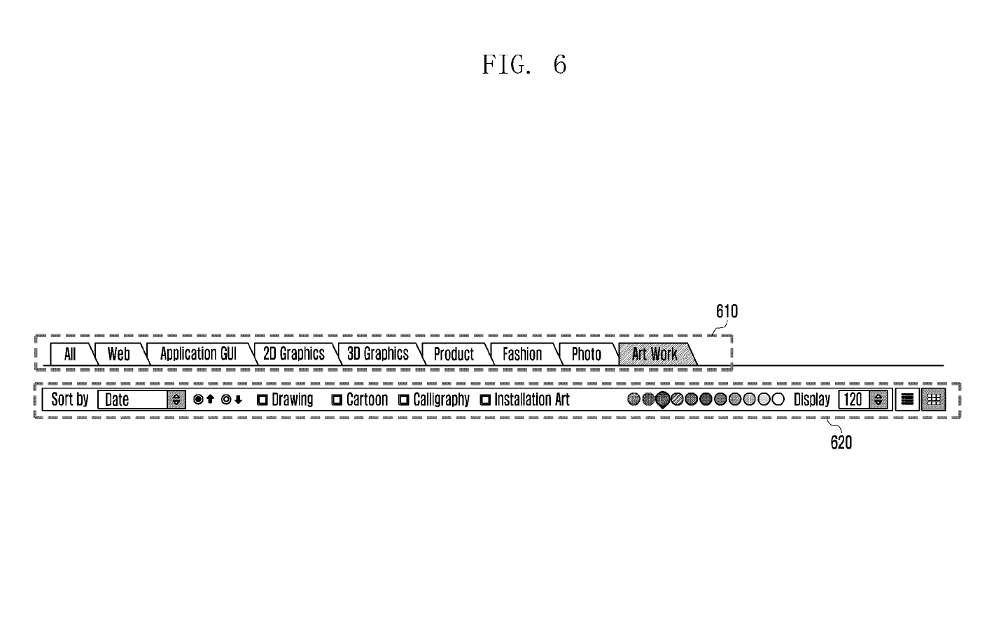

FIG. 6 illustrates an interface for searching for a creative work, which is provided by a design search unit according to one of various embodiments disclosed in the present disclosure.

Referring to FIG. 6, the design search unit 260 may provide a tab 610 by which it is possible to search for a creative work according to its field. For example, the design search unit 260 may provide a tab 610 by which it is possible to select “all categories,” “Web design,” “App design,” “2D design,” “3D design,” “product design,” “fashion design,” “photograph,” or “work of art.”

The design search unit 260 may provide an interface through which it is possible to search for a creative work according to date, evaluated score, preference, comments, or the number of times by which each image is referred to, in a detail configuration 620 within the tab 610. Especially, the design search unit 260 can search for various images uploaded to the server 110 on the basis of the color code. When members upload an image relating to a creative work to the server 110, the design search unit 260 can receive information relating to a color code and thus can provide an interface through which it is possible to search for a creative work on the basis of the input color code.

A method for exchanging a creative work by an electronic device according to various embodiments of the present invention may include: receiving, by a design polling unit, an input for selecting the type of polling to be started from a first user group; receiving, by the design polling unit, at least one piece of information relating to the polling from the first user group; generating, by a design polling unit, polling on the basis of the type of polling and the at least one piece of information; receiving, by the design polling unit, an input for selecting one of creative works provided as candidates of the polling from a second user group; analyzing, by the design polling unit, a result of the polling on the basis of the received input; and providing, by the design polling unit, the analyzed result.

The type of the polling may include first polling or second polling.

In the operation of receiving an input for selecting the type of polling, when an input selecting the second polling is received, at least one condition may be received from the first user group.

The conditions may include at least one of nation, cultural area, age, sex, and specialized field.

The at least one piece of information may be at least one from among category, title, contents, tag, color code, time limit, whether to open the result of polling, number of polling images, thumbnail, and polling image file.

The operation of analyzing a result of the polling may include, when the type of the polling is the first polling, analyzing the percentage by which the creative work has been selected.

The operation of analyzing a result of the polling may include, when the type of the polling is the second polling, analyzing the result of the polling by filtering the percentage by which the creative work has been selected, as at least one condition.

The conditions may include at least one of nation, cultural area, age, sex, and specialized field.

According to various embodiments, at least some of the devices (for example, modules or functions thereof) or the method (for example, operations) according to the present disclosure may be implemented by a command stored in a computer-readable storage medium in a programming module form. When the command is executed by one or more processors (for example, the processor), the one or more processors may execute a function corresponding to the command. The computer-readable storage medium may be, for example, the storage unit. At least some of the programming modules may be implemented (for example, executed) by, for example, the processor. At least some of the programming modules may include, for example, a module, a program, a routine, a set of instructions or a process for performing one or more functions.

The computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (for example, programming module), such as a Read Only Memory (ROM), a Random Access Memory (RAM), a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The module or programming module according to an embodiment of the present disclosure may include one or more of the above-described elements. Alternatively, some of the above-described elements may be omitted from the programming module. Alternatively, the programming module may further include additional elements. Operations executed by a module, a programming module, or other component elements according to the present disclosure may be executed sequentially, in parallel, repeatedly, or in a heuristic manner. Further, some operations may be executed according to another order or may be omitted, or other operations may be added.

A computer-readable recording medium according to various embodiments of the present invention has a program recorded therein for executing operations in an electronic device, the operations including: receiving, by a design polling unit, an input for selecting the type of polling to be started from a first user group; receiving, by the design polling unit, at least one piece of information relating to the polling from the first user group; generating, by a design polling unit, polling on the basis of the type of polling and the at least one piece of information; receiving, by the design polling unit, an input for selecting one of creative works provided as candidates of the polling from a second user group; analyzing, by the design polling unit, a result of the polling on the basis of the received input; and providing, by the design polling unit, the analyzed result.

Meanwhile, the exemplary embodiments disclosed in the specification and drawings are merely presented to easily describe technical contents of the present disclosure and help the understanding of the present disclosure and are not intended to limit the scope of the present disclosure. Therefore, all changes or modifications derived from the technical idea of the present disclosure as well as the embodiments described herein should be interpreted to belong to the scope of the present disclosure.

What is claimed is:

1. A method for exchanging a creative work by an electronic device, the method comprising:
receiving, by a design polling unit, an input for selecting a type of polling to be started from a first user group;
receiving, by the design polling unit, at least one piece of information relating to the polling from the first user group;
generating, by a design polling unit, polling on the basis of the type of polling and the at least one piece of information;
receiving, by the design polling unit, an input for selecting one of creative works provided as candidates of the polling from a second user group;
analyzing, by the design polling unit, a result of the polling on the basis of the received input; and
providing the analyzed result by the design polling unit.

2. The method of claim 1, wherein the type of the polling includes first polling or second polling.

3. The method of claim 2, wherein, in receiving an input for selecting the type of polling, when an input selecting the second polling is received, at least one condition is received from the first user group.

4. The method of claim 3, wherein the conditions comprise at least one of nation, cultural area, age, sex, and specialized field.

5. The method of claim 1, wherein the at least one piece of information comprises at least one from among category, title, contents, tag, color code, time limit, whether to open the result of polling, number of polling images, thumbnail, and polling image file.

6. The method of claim 2, wherein analyzing the result of the polling comprises, when the type of the polling is the first polling, analyzing the percentage by which the creative work has been selected.

7. The method of claim 2, wherein analyzing the result of the polling comprises, when the type of the polling is the second polling, analyzing the result of the polling by filtering the percentage by which the creative work has been selected, as at least one condition.

8. The method of claim 7, wherein the conditions comprise at least one of nation, cultural area, age, sex, and specialized field.

9. A creator intercommunication system comprising:
a first user group;
a second user group; and
a server,
wherein the server comprises a design polling unit, which receives an input for selecting a type of polling to be started from the first user group, receives at least one piece of information relating to the polling from the first user group, generates polling based on the type of polling and the at least one piece of information, receives an input for selecting one of creative works provided as candidates of the polling from the second user group, analyzes a result of the polling based on the received input, and provides the analyzed result.

10. The creator intercommunication system of claim 9, wherein the server further comprises a trend exchange unit, which receives data relating to at least one creative work from the first user group, provides the data relating to the creative work to the second user group, receives evaluation on the creative work from the second user group, and provides the evaluation to the first user group and the second user group, thereby achieving the exchange of the trend relating to the creative work.

11. The creator intercommunication system of claim 10, wherein the server further comprises a content transaction unit, which receives data relating to at least one content from the first user group, provides the data relating to the content to the second user group, and receives purchase intention for the content from the second user group, thereby mediating content transaction between the first user group and the second user group.

12. The creator intercommunication system of claim 11, wherein the server further comprises a crowdsourcing unit, which receives data relating to a project order from the first user group, provides the data relating to the project order to the second user group, and receives a participation intention relating to the project order from the second user group, thereby mediating a project order transaction between the first user group and the second user group.

13. The creator intercommunication system of claim 12, wherein the server further comprises a creator showroom unit, which provides personal on-line spaces for individual members belonging to the first user group and the second user group.

14. The creator intercommunication system of claim 13, wherein the server further comprises a design search unit, which searches for at least one creative work uploaded to the creator intercommunication system.

15. The creator intercommunication system of claim 14, wherein the server further comprises a member management unit, which manages the grade of at least one member of the creator intercommunication system and benefits corresponding to the grade.

16. A computer-readable recording medium having a program recorded therein for executing a method for exchanging a creative work by an electronic device, the method comprising: receiving, by a design polling unit, an input for selecting the type of polling to be started from a first user group; receiving, by the design polling unit, at least one piece of information relating to the polling from the first user group; generating, by a design polling unit, polling on the basis of the type of polling and the at least one piece of information; receiving, by the design polling unit, an input for selecting one of creative works provided as candidates of the polling from a second user group; analyzing, by the design polling unit, a result of the polling on the basis of the received input; and providing, by the design polling unit, the analyzed result.
